(19) United States
(12) Patent Application Publication
(10) Pub. No.: US 2023/0267144 A1
(43) Pub. Date: Aug. 24, 2023

(54) METHOD AND SYSTEM FOR CRYSTALIZING CAPTURED EMOTIONS

(71) Applicant: Hets-David Ozer, Moshav Adanim (IL)

(72) Inventor: Hets-David Ozer, Moshav Adanim (IL)

(21) Appl. No.: 18/171,393

(22) Filed: Feb. 20, 2023

Related U.S. Application Data
(60) Provisional application No. 63/312,120, filed on Feb. 21, 2022.

(51) Int. Cl. G06F 16/583; G06Q 20/06; H04L 9/40

(52) U.S. Cl. CPC G06F 16/583; G06Q 20/065; H04L 63/0823

(57) ABSTRACT

Methods and systems are disclosed for creating crystals for use as non-fungible tokens (NFTs), for transactions on the block chain.

### CROSS REFERENCES TO RELATED APPLICATIONS

This application is related to and claims priority from commonly owned U.S. Provisional Patent Application, Ser. No. 63/312,120, entitled: Method And System For Crystalizing Captured Emotions, filed on Feb. 21, 2022, the disclosure of which is incorporated by reference in its entirety herein.

### TECHNICAL FIELD

The present disclosure relates to methods and systems for creating digital items, and in particular to using digital items as non-fungible tokens (NFT) on the block chain.

### BACKGROUND

Non-fungible tokens (NFTs) are pieces of data, for example, associated with something unique, such as digital artworks. The NFT linked to the digital artwork is sold or otherwise transferred between parties, with the sale and ownership of the NFT registered on the block chain. While digital art is one type of item associated with NFTs, there are many others, such as contracts, legal status, real estate, tweets, clips, files, and, data.

### SUMMARY OF THE DISCLOSURE

The present disclosure provides methods and systems for creating crystals, also known as digital transactional objects, for use as non-fungible tokens (NFTs), for transactions on the block chain. The methods and systems provide an ex-post social guiding tool, by capturing emotions invoked by value/beliefs based human actions, crystalizing the captured emotions, and transacting the crystals, for example, by selling them using a market-based ecosystem.

The present disclosure provides a computerized platform and computer-implemented methods, where a user can create an emotional crystal, a piece of data, associated with a graphic and a non-fungible token (NFT), which is registered on the block chain. The emotional crystal is then transacted on the block chain.

The present disclosure provides a societal organizing tool, allowing people to capture beliefs, values and emotions in data, such a data files, and register the data with a registrar, such as the block chain.

It is believed that people need artworks, such as the disclosed crystal, to give them an emotional reminder of their beliefs and values, to motivate them to act according to the phrases, ideas and/or beliefs provided in the crystal. This is analogous to humanity's need for heroes, and for people to imitate them. Additionally, purchases of the crystal, analogous to the purchase of artwork, affects the whole of society, to move it forward in a positive direction, such that by their doing good, they reinforce their beliefs and values and create a better world for themselves and future generations. The creation of the crystal also ensures an emotional response from someone, which is activated, for example, by the recorded performance of good deeds.

This document references terms that are used consistently or interchangeably herein. These terms, including variations thereof, are as follows.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., a smartphone, personal digital assistant (PDA), mobile telephone or cellular telephone, a watch digitally linked to a network such as the Internet, or other wearable technology.

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine or a software based emulation of a computer.

An “application” or “software application”, includes executable software, and optionally, any graphical user interfaces (GUI), through which certain functionalities can be implemented.

A “client” is an application that runs on a computer, workstation or the like and relies on a server to perform some of its operations or functionality.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. To the extent of any conflict, the patent specification, including definitions, will control. In addition, the materials, methods and examples are illustrative only and are not intended to be limiting.

This summary is provided to introduce a selection of concepts in a simplified form that are further described below in the detailed description. This summary is not intended to be used to limit the scope of the claimed subject matter.

### BRIEF DESCRIPTION OF FIGURES

Non-limiting examples of embodiments are described below with reference to figures attached hereto that are listed following this paragraph. Identical structures, elements or parts that appear in more than one figure are generally labeled with a same numeral in all the figures in which they appear, and a numeral labeling an icon representing a given feature in a figure may be used to reference the given feature. Dimensions of components and features shown in the figures are chosen for convenience and clarity of presentation and are not necessarily shown to scale.

FIG. 1 is a diagram of an exemplary environment for the system in which embodiments of the disclosed subject matter are performed;

FIG. 2 is a diagram of the architecture of the crystal server of FIG. 1 and the system thereof;

FIG. 3 is a flow diagram of a process in accordance with embodiments of the disclosed subject matter; and,

FIG. 4 is a diagram of an example cycle or life cycle of a crystal, in accordance with embodiments of the disclosed subject matter.

### DETAILED DESCRIPTION OF THE DISCLOSURE

Before explaining at least one embodiment of the disclosure in detail, it is to be understood that the disclosure is not necessarily limited in its application to the details of construction and the arrangement of the components and/or methods set forth in the following description and/or illustrated in the drawings. The disclosed subject matter is capable of other embodiments or of being practiced or carried out in various ways.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

The present disclosure provides for multiple entities to create an emotional crystal or crystal, also known as a digital transactional object, and link the created crystal with a graphic, for example, for identification, issue the crystal for display on a web site or the like, and once a transaction for the crystal is made, such as a sale, register the transaction on the block chain.

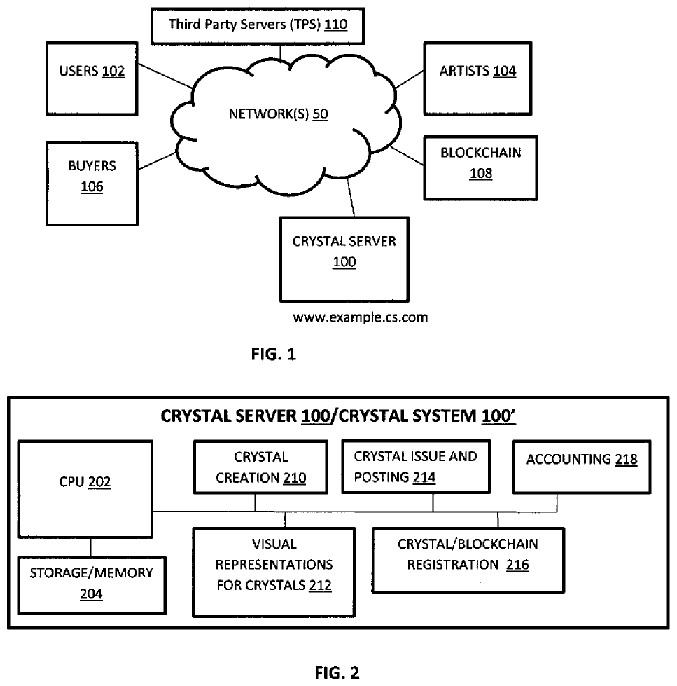

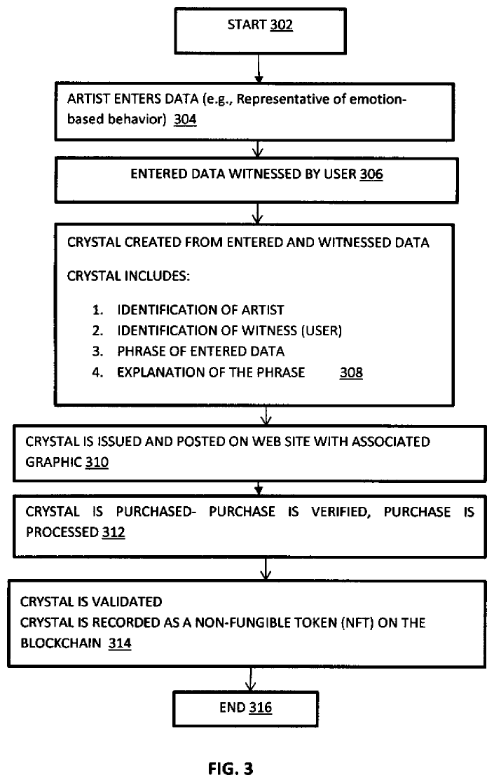

Reference is now made to FIG. 1, which shows an exemplary operating environment, including a network(s) 50, to which is linked a crystal server (CS) 100, also known as a home, main or central server. The crystal server 100 also includes a system 100′ (FIG. 2), which, for example, operates a platform, for creating and issuing crystals, and sending the crystals for display, for example, on a third party server (TPS) 110, or to the block chain, represented by the server 108. The terms “system”, as denoted by element number 100′, and “platform” are used interchangeably herein.

The system 100′, for example, may also include other computers, including servers, components, and applications, e.g., client applications, associated with crystal server 100, as detailed below. The system 100′ manages and controls communications between it (i.e., the crystal server 100) and multitudes of users, represented by the server 102, multitudes of artists, represented by the server 104, buyers for the crystals, represented by the server 106, block chains 108 (e.g., Ethereum, Polka Dot, and Solana), and servers of third parties or third party servers (TPS) 110 (e.g., open sea (www.opensea.com)), where the issued crystals may be displayed and presented for sale or other transactions, and the like. The servers 100, 102, 104, 106, 108, 110 communicate with each other over the network(s) 50, either directly or indirectly, by electronic and/or data communications.

The network(s) 50 is, for example, a communications network, such as a Local Area Network (LAN), or a Wide Area Network (WAN), including public networks such as the Internet, cellular networks, and the like. As shown in FIG. 1, the network 100, may be a single network, such as the Internet, but is typically a combination of networks and/or multiple networks including, for example, cellular or Bluetooth or other networks. “Linked” as used herein includes both wired or wireless links, either direct or indirect, and placing the computers, including, servers, components and the like, in electronic and/or data communications with each other, directly and/or indirectly.

FIG. 2 shows architecture for the system 100′ of the disclosure, in, for example, the crystal server 100. While the system 100′ is shown on the crystal server 100, the system 100′ may be spread across numerous servers, computerized components and the like, including servers in the cloud (e.g., cloud servers, not shown).

The architecture for the system 100′ includes one or more components, engines, modules and the like, for providing numerous additional server functions and operations, and, for running the processes of the system 100′. Those components, engines and modules of the system 100′ are shown and described below, but additional components, engines and modules are also permissible as part of the system 100′, to perform any additional functions. For example, a “module” includes one or components for storing instructions, (e.g., machine readable instructions) for performing one or more processes, and including or associated with processors, for example, the CPU 202, for executing the instructions. The crystal server 100 may be associated with additional storage, memory, caches and databases, both internal and external thereto. For explanation purposes, the crystal server 102 may have a uniform resource locator (URL) of, for example, www.example.cs.com.

The architecture of the system 100′ (platform), as shown, for example, in the crystal server 100, includes a central processing unit (CPU) 202 formed of one or more processors, electronically connected, i.e., either directly or indirectly, including in electronic and/or data communication with storage/memory 204, a crystal creator or crystal creation module 210, a visual representer or visual representation module for crystals 212, a crystal issue and poster or a crystal issuing and posting module 214, a crystal/block chain registrar or crystal/bock chain registration module 216, and an accounting module 218 to handle financial and other transactions associated with crystals created and issued by the system 100′. The aforementioned components, modules, and engines are linked to each other, either directly or indirectly, for communication between them either directly or indirectly, with some linkages noted below.

The Central Processing Unit (CPU) 202 is formed of one or more processors, including microprocessors, for performing the crystal server 100 and system 100′ (platform) functions and operations detailed herein, including controlling the modules 210, 212, 214, 216, 218. The processors are, for example, conventional processors, such as those used in servers, computers, and other computerized devices, including hardware processors. For example, the processors may include x86 Processors from AMD (Advanced Micro Devices®) and Intel®, Xenon® and Pentium® processors from Intel, as well as any combinations thereof.

The storage/memory 204 is any conventional storage media. The storage/memory 204 stores machine executable instructions for execution by the CPU 202, to perform the processes of the disclosure. The storage/memory 204 also includes machine executable instructions associated with the operation of the components, including the modules 210, 212, 214, 216 and 218. The storage/memory 204 also, for example, stores rules and policies for the system 100′ and the crystal server 100.

The processors of the CPU 202 and the storage/memory 204, although shown as a single component for representative purposes, may be multiple components. These multiple components may be outside of the crystal server 100 and/or the system 100′, and linked to the network 100.

The crystal creator or crystal creation module 210 includes instructions executable by the CPU 202 to create crystals. The crystal creator 210 provides instructions for to the CPU 202 for processing received data and creating the crystal from the data, as a data file, data package, data object, data piece, or the like. Data is received from an artist (represented by the server 104), about a user (represented by the server 104). The data may include the words or phrase, “provides service from the heart”. In providing the phrase to the system 100′, the artist behaves in a way that itself is a work of art, equivalent to emotion based behavior, as the emotion of the artist, i.e., that the user “provides service from the heart” is captured in a physical object, e.g., a data file. The entered data is then witnessed and authenticated by the user (represented by the server 102). The crystals are made in accordance with a crystal communication protocol, an example of which is as follows.
1. The identification of the user, known also as a “Do Gooder” (DG), and the identification of the artist, known also as a “Do Good Seeker” (DGS), is made and verified by the module 210 and the system 100′. There is also a short description of the positive value of the phrase, e.g., “Joe really works hard for others”, and a short factual description of the phrase, e.g., “Joe has been a done great handyman work for over twenty years, supports and gives his time to many charitable causes”.
2. A crystal card is created and stored (in storage associated with the module 210 (not shown)). The crystal card includes an evidence file, which includes, for example, data such as digitized graphics, pictures, photographs, images videos, and factual descriptions thereof
3. A visual representation generator for the created crystal, performed by module 212, with a visual representation changeable by the buyer (represented by the server 106), or any other party transacting the crystal, either before or after the crystal has been issued.
4. The module 210 automatically provides for the creation of a smart contract, which allocate proceeds of transactions (e.g., sales), for example, to the Do Gooder (DG) 50%, Do Good Seeker (DGS) 25%, and the entity associated with the crystal server 100/crystal creation 25%.

The visual representer 212 generates, for the created crystal, a visual representation (e.g., graphic, icon, or the like) for/associated with, and typically linked to the created crystal, and which is changeable by the buyer (represented by the server 106), or any other party transacting the crystal, either before or after it has been issued.

The crystal issue and poster 214 issues the crystal once created, so it is available for transactions, e.g., sales. The issued crystal is then posted, for example, transmitted by the module 214 to destinations, e.g., web sites and the like, for display, such as on TPS servers 110, or servers associated with the crystal server 100, including web sites hosted by the crystal server 100.

The Crystal/Block registration module 216 functions to have the now created and issued crystal and, for example, the associated smart contract, registered as a non-fungible token (NFT), on the block chain 108. For example, the block chain 108 may be the Ethereum Block Chain.

The accounting module 218 handles transactions associated with each crystal, both before and after the crystal is created and issued. The users and artists, and data associated therewith, as well as all smart contracts (and associated data and information) for system associated crystals, are also administered and stored (also on external storage (not shown), by the module 218.

Attention is now directed to FIG. 3, which shows a flow diagram detailing computer-implemented processes in accordance with embodiments of the disclosed subject matter. Reference is also made to elements shown in FIGS. 1 and 2. The process and sub-processes of FIG. 3 are computerized processes performed by the system 100′. The aforementioned processes and sub-processes can be, for example, performed automatically, and, for example, in real time.

The process begins at the START block 302.

The process moves to block 304, where the artist enters (inputs) data into the system 100′ to create the crystal. The crystal to be created is, for example, representative of emotional behavior. The process moves to block 306, where the artist (represented by the server 104) entered (inputted) data is witnessed, and typically also verified, by the user (represented by the server 102), for example, via user input of the verification.

The process moves to block 308, where the crystal is created, for example, by the modules 210, 212, 218 in accordance with a protocol, for example, as follows.
1. The identification of the user, known also as a “Do Gooder” (DG), and the identification of the artist, known also as a “Do Good Seeker” (DGS), is made and verified by the module 210 and the system 100′. There is also a short description of the positive value of the phrase, e.g., “Joe really works hard for others”, and a short factual description of the phrase, e.g., “Joe has been a done great handyman work for over twenty years and supports gives his time to many charitable causes”.
2. A crystal card is created and stored (in storage associated with the module 210 (not shown)). The crystal card includes an evidence file, which includes for example, digitized graphics, pictures, photographs, images, videos, and factual descriptions thereof
3. A visual representation generator for the created crystal, performed by module 212, with a visual representation changeable by the buyer (represented by the server 106), or any other party transacting the crystal, either before or after the crystal has been issued.
4. The module 210 automatically provides for the creation of a smart contract, which allocate proceeds of transactions (e.g., sales), for example, to the Do Gooder (DG) 50%, Do Good Seeker (DGS) 25%, and the entity associated with the crystal server 100/crystal creation 25%. The smart contract is assigned or otherwise linked to the crystal.

These are a basic protocol, and other protocol steps, processes and the like can be added. Also, the aforementioned protocol steps, processes and the like may be changed, as desired, depending on the crystals being created, transacted and administered.

Moving to block 310, the crystal, now created, and now optionally associated with graphics at this time, is issued. The now-issued crystal is posted with a graphic, selected or otherwise assigned by the module 212, or with the graphic associated therewith upon creation. The posting includes, for example, the module 210 transmitting the crystal and associated graphic, electronically, over the network(s) 50, to destination, such as server 110, a web site for display and presentation of the crystal and associated graphic. The web site may be, for example Open Sea (www.opensea.com).

At block 312, the presented crystal is transacted, for example sold or subjected to a sale. The process moves to block 314, where the crystal is validated, for example by recording the crystal, associated graphic and data associated therewith on the block chain 108, for example as an NFT. The block chain 108, for example, may be the Ethereum Block, or Ethereum based block chains, such as Polka Dot and Solera, and other Block Chains.

The process moves to block 316 where it ends. The process may be repeated for as long as desired.

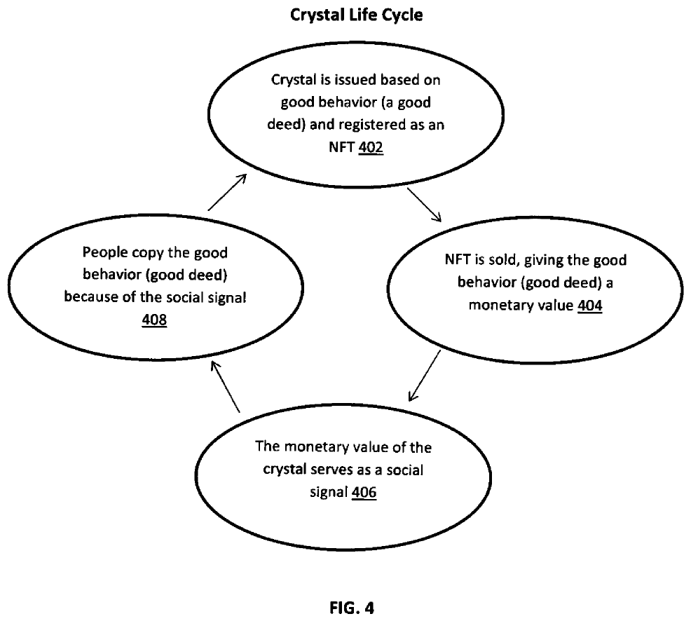

FIG. 4 is a diagram showing a cycle of relations between the various aspects of the disclosed crystal. At block 402, the crystal is created and issued, for example, regarding good behavior of a Do Gooder, and registered on the block chain 108 as an NFT. At block 404, the NFT is sold, rewarding the good behavior of the Do Gooder with value, e.g., a monetary value. At block 406, the monetary value acts as a social signal. Moving to block 408, the NFT serves as a model of acceptance for people copying the good behavior because of the social signal. The process returns to block 402, were cycle resumes.

The disclosure also provides for a computer usable non-transitory storage medium having a computer program embodied thereon for causing a suitably programmed system, e.g., computer system including computers, servers and the like, to create and issue a crystal, for association with a graphic and linked to an NFT, over a communications network, by performing various steps, when such program is executed on the system.

The disclosed subject matter is directed to a method for creating a digital transactional object, known also as a crystal. The method comprises: receiving first input from a first entity (e.g., an artist) corresponding to establishing the digital transactional object; receiving second input from a second entity (e.g., a user) witnessing the existence of the first input; creating the digital transactional object comprising: providing an identification for the first entity; providing an identity for the second entity; and, providing textual data into at least one data file, the textual data representative of the digital transactional object; providing a visual representation to the digital transactional object and linking the graphic to the digital transactional object; issuing the digital transactional object, so as to be accessible over a communications network, and identifiable via the visual representation; and, responding to receiving an indication of a transaction involving the issued digital transactional object over the communications network, by providing an indication of validation for the digital transactional object.

Optionally, the method is such that the indication of validation for the digital transactional object includes recording the digital transactional object on a blockchain.

Optionally, the method is such that the blockchain is selected from the group consisting of: the Ethereum Block chain and Ethereum-based block chains including Polka Dot and Solera.

Optionally, the method is such that the visual representation includes a graphic, a digital image and/or icon.

Optionally, the method is such that the communications network includes the Internet and/or the world wide web.

Optionally, the method is such that the transaction includes a sale.

Optionally, the method is such it additionally comprises: assigning a smart contract to the issued digital transactional object.

Optionally, the method is such that the digital transactional object includes a non-fungible token (NFT).

Optionally, the method is such that the textual data includes a first textual description and a second textual description based on the first textual description.

Optionally, the method is such that the creating the digital transactional object additionally comprises: associating digital data with the textual data.

Optionally, the method is such that the digital data includes digitized graphics, digitized pictures, digitized photographs, digitized images, digitized videos, and optionally textual descriptions associated therewith.

The disclosed subject matter is directed to a computer system for creating a digital transactional object, also known as a crystal. The computer system comprises: a non-transitory storage medium for storing computer components; and, a computerized processor for executing the computer components. The computer components comprise: a first module for receiving first input from a first entity corresponding to establishing the digital transactional object, and receiving second input from a second entity witnessing the existence of the first input; a second module for creating the digital transactional object by processes including: providing an identification for the first entity, providing an identity for the second entity, and providing textual data into at least one data file, the textual data representative of the digital transactional object; a third module for providing a visual representation to the digital transactional object and linking the graphic to the digital transactional object; a fourth module for issuing the digital transactional object, so as to be accessible over a communications network, and identifiable via the visual representation; and, a fifth module for responding to receiving an indication of a transaction involving the issued digital transactional object over the communications network, by providing an indication of validation for the digital transactional object.

Optionally, the computer system is such that the second module obtains digital data associated with the textual data for the digital transactional object.

Optionally, the computer system is such that the fifth module provides the indication of validation for the digital transactional object by recording the digital transactional object on a blockchain.

Optionally, the computer system additionally comprises: a sixth module for assigning a smart contract to the issued digital transactional object.

Optionally, the computer system is such that the digital transactional object includes a non-fungible token (NFT).

The disclosed subject matter is directed to a computer usable non-transitory storage medium having a computer program embodied thereon for causing a suitably programmed system to create a digital transactional object, by performing the following steps when such program is executed by the system. The steps comprise: receiving first input from a first entity corresponding to establishing the digital transactional object; receiving second input from a second entity witnessing the existence of the first input; creating the digital transactional object comprising: providing an identification for the first entity; providing an identity for the second entity; and, providing textual data into at least one data file, the textual data representative of the digital transactional object; providing a visual representation to the digital transactional object and linking the graphic to the digital transactional object; issuing the digital transactional object, so as to be accessible over a communications network, and identifiable via the visual representation; and, responding to receiving an indication of a transaction involving the issued digital transactional object over the communications network, by providing an indication of validation for the digital transactional object.

Optionally, the computer usable non-transitory storage medium is such that the indication of validation for the digital transactional object includes recording the digital transactional object on a blockchain.

Optionally, the computer usable non-transitory storage medium is such that the digital transactional object includes a non-fungible token (NFT).

Optionally, the computer usable non-transitory storage medium is such that the steps for creating the digital transactional object additionally comprise: associating digital data with the textual data.

The implementation of the method and/or system of embodiments of the disclosure can involve performing or completing selected tasks manually, automatically, or a combination thereof. Moreover, according to actual instrumentation and equipment of embodiments of the method and/or system of the disclosure, several selected tasks could be implemented by hardware, by software or by firmware or by a combination thereof using an operating system or a cloud-based platform (such as those provided by Amazon Web Services™ or Microsoft® Azure™).

For example, hardware for performing selected tasks according to embodiments of the disclosure could be implemented as a chip or a circuit. As software, selected tasks according to embodiments of the disclosure could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, cloud-based platforms, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

In the description and claims of the present application, each of the verbs, “comprise,” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

1. A method for creating a digital transactional object comprising:
receiving first input from a first entity corresponding to establishing the digital transactional object;
receiving second input from a second entity witnessing the existence of the first input;
creating the digital transactional object comprising:
providing an identification for the first entity;
providing an identity for the second entity; and
providing textual data into at least one data file, the textual data representative of the digital transactional object;
providing a visual representation to the digital transactional object and linking the graphic to the digital transactional object;
issuing the digital transactional object, so as to be accessible over a communications network, and identifiable via the visual representation; and
responding to receiving an indication of a transaction involving the issued digital transactional object over the communications network, by providing an indication of validation for the digital transactional object.

2. The method of claim 1, wherein the indication of validation for the digital transactional object includes recording the digital transactional object on a blockchain.

3. The method of claim 2, wherein the blockchain is selected from the group consisting of: the Ethereum Block chain and Ethereum-based block chains including Polka Dot and Solera.

4. The method of claim 1, wherein the visual representation includes a graphic, a digital image and/or icon.

5. The method of claim 1, wherein the communications network includes the Internet and/or the world wide web.

6. The method of claim 1, wherein the transaction includes a sale.

7. The method of claim 1, additionally comprising: assigning a smart contract to the issued digital transactional object.

8. The method of claim 1, wherein the digital transactional object includes a non-fungible token (NFT).

9. The method of claim 1, wherein the textual data includes a first textual description and a second textual description based on the first textual description.

10. The method of claim 1, wherein the creating the digital transactional object additionally comprises: associating digital data with the textual data.

11. The method of claim 10, wherein the digital data includes digitized graphics, digitized pictures, digitized photographs, digitized images, digitized videos, and optionally textual descriptions associated therewith.

12. A computer system for creating a digital transactional object comprising:
a non-transitory storage medium for storing computer components; and
a computerized processor for executing the computer components comprising:
a first module for receiving first input from a first entity corresponding to establishing the digital transactional object, and receiving second input from a second entity witnessing the existence of the first input;
a second module for creating the digital transactional object by processes including: providing an identification for the first entity, providing an identity for the second entity, and providing textual data into at least one data file, the textual data representative of the digital transactional object;
a third module for providing a visual representation to the digital transactional object and linking the graphic to the digital transactional object;
a fourth module for issuing the digital transactional object, so as to be accessible over a communications network, and identifiable via the visual representation; and,
a fifth module for responding to receiving an indication of a transaction involving the issued digital transactional object over the communications network, by providing an indication of validation for the digital transactional object.

13. The computer system of claim 12, wherein the second module obtains digital data associated with the textual data for the digital transactional object.

14. The computer system of claim 12, wherein the fifth module provides the indication of validation for the digital transactional object by recording the digital transactional object on a blockchain.

15. The computer system of claim 12, additionally comprising: a sixth module for assigning a smart contract to the issued digital transactional object.

16. The computer system of claim 12, wherein the digital transactional object includes a non-fungible token (NFT).

17. A computer usable non-transitory storage medium having a computer program embodied thereon for causing a suitably programmed system to create a digital transactional object, by performing the following steps when such program is executed by the system, the steps comprising:
receiving first input from a first entity corresponding to establishing the digital transactional object;
receiving second input from a second entity witnessing the existence of the first input;
creating the digital transactional object comprising:
providing an identification for the first entity;
providing an identity for the second entity; and
providing textual data into at least one data file, the textual data representative of the digital transactional object;
providing a visual representation to the digital transactional object and linking the graphic to the digital transactional object;
issuing the digital transactional object, so as to be accessible over a communications network, and identifiable via the visual representation; and
responding to receiving an indication of a transaction involving the issued digital transactional object over the communications network, by providing an indication of validation for the digital transactional object.

18. The computer usable non-transitory storage medium of claim 17, wherein the indication of validation for the digital transactional object includes recording the digital transactional object on a blockchain.

19. The computer usable non-transitory storage medium of claim 17, wherein the digital transactional object includes a non-fungible token (NFT).

20. The computer usable non-transitory storage medium of claim 17, wherein the steps for creating the digital transactional object additionally comprise: associating digital data with the textual data.
